(19) United States
(12) Patent Application Publication
(10) Pub. No.: US 2024/0034652 A1
(43) Pub. Date: Feb. 1, 2024

(54) METHOD FOR INHIBITING STRUVITE FORMATION

(71) Applicant: John Victor Van Slyke, Vancouver (CA)

(72) Inventor: John Victor Van Slyke, Vancouver (CA)

(21) Appl. No.: 17/815,336

(22) Filed: Jul. 27, 2022

(51) Int. Cl. C02F 1/66; C02F 1/44

(52) U.S. Cl. CPC C02F 1/66; C02F 1/441; C02F 2209/14; C02F 2209/06; C02F 2103/20

(57) ABSTRACT

A method of reducing or inhibiting struvite formation that occurs during the process of utilizing dilution water to assist in the removal and management of dairy cow waste matter. The present invention includes embodiments that access dilutant sources from any combination of sources that include well water, collected rain water, municipal water or water recovered by reverse osmosis of a previous manure slurry. Employing the method of the present invention further includes estimating the volume of manure slurry and further measuring and recording the total ammonium nitrogen and pH thereof. A calculation is made to determine the amount of sulfuric acid needed in order to eliminate the total ammonium nitrogen in the manure slurry. Acid is introduced into the dilutant and is utilized to clean a barn floor of animal waste resulting in the creation of the manure slurry wherein the manure slurry has no presence of struvite.

### FIELD OF THE INVENTION

The present invention relates generally to dairy cow manure management, more specifically but not by way of limitation a method of reducing or inhibiting struvite formation that occurs during the process of utilizing dilution water to assist in the removal and management of dairy cow manure wherein the present invention inhibits or substantially reduces the struvite formation in the manure slurry.

### BACKGROUND

As is known in the art, dairy cows are often kept in a confined area for a substantially long period of time. Typically, dairy cows are milked twice a day in barns and these barns can be configured to house hundreds of dairy cows. As the cows are fed in these barns and remain therein for a long period of time, the dairy cows will defecate and urinate in the stalls in which they are being stored. Most dairy cow barns have floors that are manufactured from concrete and are shaped to assist in the removal of the fecal matter and urine. There are two common methods of removing the fecal matter and urine from the floor of the dairy cow barn. In a first method, the barn is equipped with a scraper wherein the scraper will push the fecal matter into a trough at one end of the barn. Once the fecal matter is in the trough the matter is mixed with water so that it may be pumped away to an area often referred to as a lagoon wherein the material can be repurposed. A second common method for removing the fecal matter from the floor of the barn is through utilization of a flushing system. The flushing system will use water to wash the fecal matter off the floor towards one end of the barn into a trough wherein the slurry is then pumped out of the trough.

While the aforementioned methods are effective for their intended objective, a common problem exists which creates additional maintenance and wear on equipment. The fecal/urine slurry naturally contains ammonium, magnesium and phosphorus. Dairy cow manure is collected and stored using water as a dilutant to allow pumps to move it to storage. During that process ammonium, magnesium and phosphorus are found dissolved in that water. These elements naturally occur and when they are found in appropriate concentrations, by way of example but not limitation, 1:1:1, they will combine as struvite. These elements naturally occur and will combine as struvite under most conditions. The struvite is a mineral which will attach as a white precipitate to surfaces such as but not limited to the pumps and pipes of the fecal slurry removal system. The struvite development will impede the slurry flow in pipes, reduce the effectiveness of pumps, clog the pump screens and damage the pump impellers. Dairy cow farm workers must often remove struvite by manually chipping it away or with acid treatment, which involves the disposal of the resulting byproducts. Some dairy cow farmers will recover the dilutant water for recycling, using reverse osmosis. This process allows the untreated ammonia to pass through as acceptable in order to replenish flush, wash and drinking water systems in the barn. Ammonium ions are too small to be captured by reverse osmosis membranes and as such will accumulate in systems that recycle water extracted from manure slurries. The ammonium sulfate molecule is large enough to be rejected by the reverse osmosis membrane as part of the dissolved solids utilized for field applications.

It is intended within the scope of the present invention to provide a method to be employed in water recycling applications involving manure slurries wherein the present invention inhibits the development of struvite in the mechanical components of the recycling system. This invention is not restricted to those who use Reverse Osmosis, while reverse osmosis is an example of filtering via molecule sizes facilitating a stream that will be rejected, or not-filtered and further creating a stream that is accepted and as such passing through the filter. In the case a scenario where reverse osmosis is not included in the process, the present invention will create the ammonium sulphate and be transported to a storage lagoon where it will be stored and removed for field application. An additional benefit of the present invention is the fact that ammonium sulphate will not volatilize to lose the nitrogen benefit of ammonium thereby reducing the nitrogen loss which can be as high as fifty percent. A further benefit is in the use of sulfuric acid to create ammonium sulphate and thereby contribute sulfur to the nutrient inventory.

### SUMMARY OF THE INVENTION

It is the object of the present invention to provide a method operable to inhibit struvite formation in a manure slurry wherein the present invention is employed in manure collection system wherein a combination of manure, urine and dilutant, typically water, are present.

Another object of the present invention is to provide a method configured to provide dosing of a dilutant that is utilized in barn manure and urine removal so as to inhibit development of struvite in a produced manure slurry wherein the present invention measure or estimates the amount of total ammonia nitrogen.

A further object of the present invention is to provide a method operable to inhibit struvite formation in a manure slurry wherein the present invention includes adding an acid to the dilutant prior to the dilutant being utilized to remove manure and urine from a barn floor.

Still another object of the present invention is to provide a method configured to provide dosing of a dilutant that is utilized in barn manure and urine removal so as to inhibit development of struvite in a produced manure slurry wherein the method includes calculation of ammonia present in order to determine the amount of acid needed to be added to the dilutant.

An additional object of the present invention is to provide a method operable to inhibit struvite formation in a manure slurry wherein the present invention further includes the step of routinely testing the manure slurry for total ammonium nitrogen.

Yet a further object of the present invention is to provide a method configured to provide dosing of a dilutant that is utilized in barn manure and urine removal so as to inhibit development of struvite in a produced manure slurry wherein a primary objective of the method of the present invention is to maintain acceptable levels of unreacted ammonium.

Another object of the present invention is to provide a method operable to inhibit struvite formation in a manure slurry wherein an objective of the method of the present invention is to reduce the total ammonium nitrogen to at least a level below one hundred parts per million so as to inhibit formation of struvite.

An alternate object of the present invention is to provide a method configured to provide dosing of a dilutant that is utilized in barn manure and urine removal so as to inhibit development of struvite in a produced manure slurry wherein in a preferred embodiment sulfuric acid is added to the dilutant.

Still a further object of the present invention is to provide a method operable to inhibit struvite formation in a manure slurry wherein the balanced reaction accomplished utilizing the method of the present invention is 2NH₃+H2SO₄=(NH₄)₂SO₄.

An additional object of the present invention is to provide a method configured to provide dosing of a dilutant that is utilized in barn manure and urine removal so as to inhibit development of struvite in a produced manure slurry wherein sulfuric acid is utilized to neutralize the free NH₃ in the manure slurry and combine both nitrogen ions with sulfuric acid to create ammonium sulfate.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagram of a preferred embodiment of the method of the present invention; and

FIG. 2 is a schematic of a flow path of dilutant used in the method of the present invention having a recycled dilutant stream; and

FIG. 3 is a schematic of a flow path of dilutant having used in the method of the present invention wherein the manure slurry is transported to storage.

### DETAILED DESCRIPTION

Referring now to the drawings submitted herewith, wherein various elements depicted therein are not necessarily drawn to scale and wherein through the views and figures like elements are referenced with identical reference numerals, there is illustrated a method for inhibiting struvite formation 100 constructed according to the principles of the present invention

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

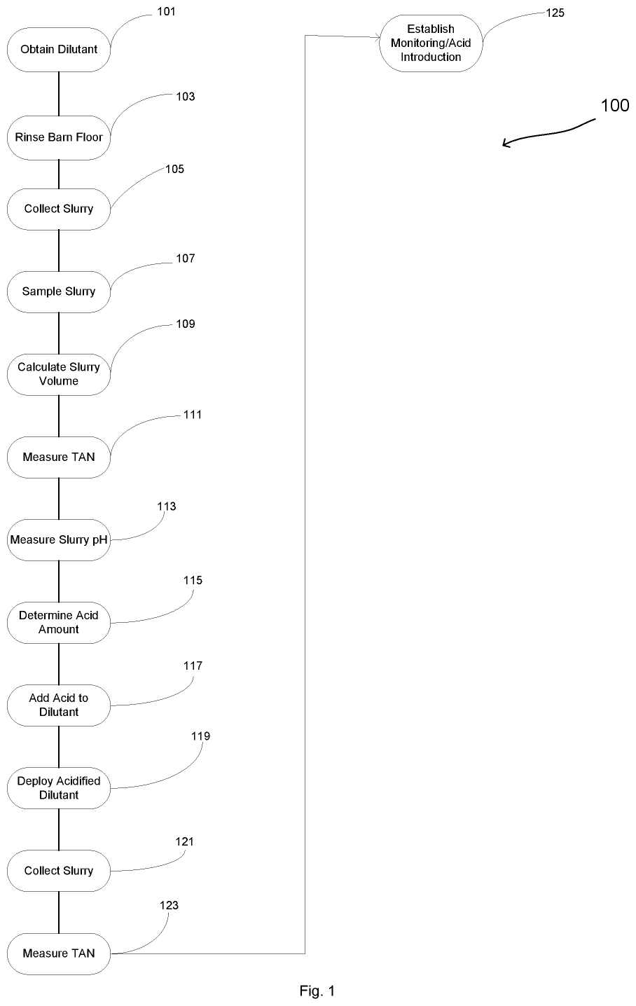

Now referring to the Figures submitted as a part hereof, the method for inhibiting struvite formation 100 is outlined herein in FIG. 1. It should be understood within the scope of the present invention that the exemplary workflow diagrammed in FIG. 1 herein could deviate and wherein the order of the steps could vary and still achieve the desired outcome of the method for inhibiting struvite formation 100. In step 101, a user of the method for inhibiting struvite formation 100 will obtain a desired dilutant to be utilized during execution of the present invention. It should be understood within the scope of the present invention that the dilutant could be but is not limited to collected rain water, well water, recycled dilutant, municipal water or any combination thereof so as to have the required volume in order to achieve the desired objective of removing fecal and urine matter from a barn floor. Step 103, the dilutant will be directed utilizing proper equipment across a barn floor, directed into a trough of collected waste matter or a combination thereof so as to achieve the desired cleaning of the barn floor. Step 105, a slurry of manure waste matter is collected wherein the slurry will contain manure, urine and dilutant. The slurry is collected in a trough or similar element adjacent to or proximate the barn floor that was rinsed with the dilutant. In step 107, a sample of the slurry is retrieved wherein the sample will be tested as further discussed herein. It should be understood within the scope of the present invention that the sample volume could vary as needed for proper testing and could be collected in various alternate suitable vessels.

In step 109, a calculation of the slurry volume will be performed. An estimation of the volume of a typically collected slurry is desired in order to calculate a proper amount of additive to add to the dilutant as is further discussed herein. Step 111, the slurry sample will be measured for Total Ammonium Nitrogen(TAN) and the amount will be recorded utilizing suitable techniques. In step 113, the sample slurry will further be tested for pH and wherein the pH reading will additionally be recorded with the measured amount of total ammonium nitrogen. Step 115, ensuing the measuring of the pH and total ammonium nitrogen of the slurry, and further knowing the volume thereof, a user of the method for inhibiting struvite formation 100 will calculate and determine the amount of acid needed for addition to the dilutant to be utilized in the next cycle of barn floor rinsing and slurry production.

In step 117, prior to execution of rinsing of a barn floor or adding dilutant to collected animal waste, an acid, preferably sulfuric acid is added to the dilutant. It should be understood that the acid could be added to the dilutant at various locations or alternate times during the method of the present invention. Step 119, the acidified dilutant is utilized in the rinsing of the barn floor or in the adding to collection of manure in order to create a slurry. In step 121, the slurry is collected wherein the slurry has been created with the acidified dilutant. Step 123, the total ammonium nitrogen of the slurry is measured and recorded. It is desired within the scope of the present invention to ensure inhibiting of struvite formation that the total ammonium nitrogen be less than one hundred parts per million. In step 125, a protocol is established and executed for the measuring of total ammonium nitrogen so as to determine the amount of sulfuric acid to be introduced into the dilutant prior to each use of the dilutant in the aforementioned process.

An example of the method of the present invention is as follows. In use, An initial assumption that nine hundred parts per million of total ammonia nitrogen dissolved in thirty thousand liters of a manure slurry collection having a pH of 8. It should be understood within the scope of the present invention that the total ammonium nitrogen is the sum of both the NH₃ and NH₄. The volume of the manure slurry is constantly changing as material is discharged to the next process, to be stored, replenished or recycled. Sulfuric acid is utilized to neutralize NH₃ and combine both nitrogen ions with sulfuric acid to create ammonium sulfate. The manure slurry is 1 mixed with proper impellers and similar equipment and as such there is needed enough sulfuric acid to reduce the total ammonium nitrogen count to an acceptable level before recycling the dilutant in the slurry mix or storing it. Utilizing the starting measurement of nine hundred parts per million with the assumption that all is NH₃ and the average volume of the manure slurry is relatively consistent the amount of sulfuric acid needed is calculated. The balanced reaction is: 2NH₃+H2SO₄=(NH₄)2SO₄. In this scenario thirty-four grams of ammonia requires ninety-eight grams of sulfuric acid. Extrapolating to the larger estimated volume, thirty thousand liters of water with nine hundred parts per million NH₃ will contain twenty-seven kilograms of NH₃, will require approximately seventy-eight kilograms of sulfuric acid. Knowing the concentration of liquid sulfuric acid, an estimate of how many liters of sulfuric acid you need by dividing seventy-eight kilograms by the acid strength percentage. As the manure slurry is discharged to a following process a sample taken at this point which will indicate the unreacted amount of total ammonium nitrogen which indicates the ammonium level to be passed to storage or through any reverse osmosis process to recover water for recycling. Adjustment of the sulfuric acid dosage on a regular basis, the total ammonium nitrogen level can be maintained at an acceptable level and any ammonium sulfate in storage will retain nitrogen with some sulfur to be utilized for fertilizing crops or other desired application.

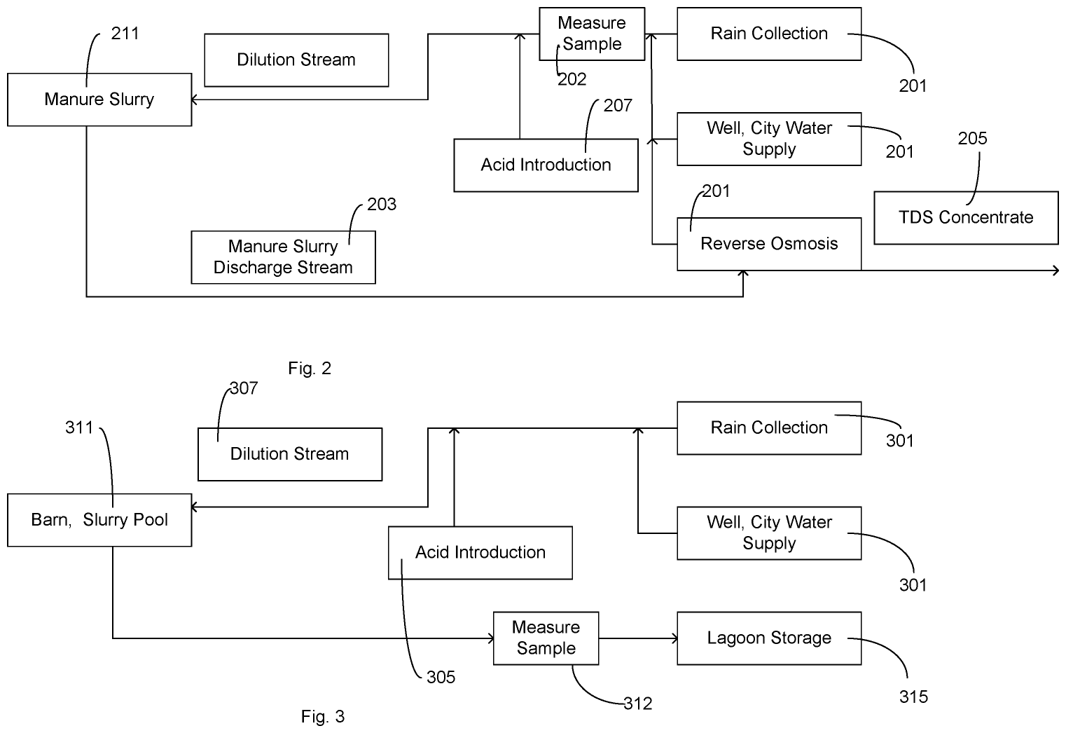

Referring now to FIG. 2 submitted herewith, an exemplary dilutant flow utilizing at least a portion of recycled dilutant is diagrammed therein. The dilutant flow utilizing at least a portion of recycled dilutant will draw raw dilutant from three dilutant sources 201. It should be understood within the scope of the present invention that the sources 201 include a dilutant source that has been filtered by reverse osmosis of a manure slurry discharge source 203, well water, collected rain water and municipal water supply. It should be understood within the scope of the present invention that the quantities from each source could vary. The manure slurry discharge source 203 ensuing filtering by reverse osmosis thereof additionally produced a total dissolved solid concentrate 205 which is routed to a suitable collection apparatus to be utilized for desired application. As the combination of the three dilutant sources 201 is pumped out, an amount of sulfuric acid is executed at an introduction location 207. It should be understood within the scope of the present invention that the sulfuric acid could be added to the combined dilutant stream or at any one of the three dilutant sources 201. At location 202, a sample of the dilutant is taken and measured for ammonia that has potentially escaped the sulfuric acid reaction, thereby providing an estimation of a required increase in acid may be necessary at introduction location 207. The acidified dilutant stream is deployed in the barn as required resulting in the creation of the manure slurry 211 which is then discharge via the manure slurry discharge source 203 wherein the aforementioned cycle is continuously repeated.

Referring now to FIG. 3 submitted as a part hereof, a diagram of dilutant flow wherein the manure slurry 311 is directed to storage for other uses is diagrammed therein. The dilutant sources 301 are taken from in a volume required to produce sufficient dilutant volume to execute the needed task of barn cleaning and manure slurry 311 production. Intermediate the dilutant sources 301 or at the point of storage of either, the dilutant is acidified with the calculated amount of sulfuric acid in order to produce the desired result of inhibiting struvite formation in the manure slurry 311. At location 305, a sample of the dilutant is taken and measured for ammonia that has potentially escaped the sulfuric acid reaction, thereby providing an estimation of a required increase in acid may be necessary at introduction location 312. The acidified dilutant stream 309, wherein acid was added at the acid introduction location 305, is employed in the barn floor rinsing and ensuing creation and collection of the manure slurry 311, the manure slurry 311 is moved utilizing suitable equipment to a lagoon storage 315 wherein the manure slurry can be employed for desired applications. It should be understood within the scope of the present invention that a barn floor can be scraped and the animal waste matter accumulated by scraping can subsequently have the dilutant added thereto in order to create the slurry.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the claims.

What is claimed is:

1. A method of inhibiting struvite formation that occurs during a process of removal and management of animal waste matter wherein the method comprises the steps of:
accessing at least one source of a dilutant, wherein the dilutant is water from a plurality of sources;
creating a slurry, wherein animal waste matter is combined with the at least one source of a dilutant to create the slurry;
collecting the slurry, wherein the slurry of the dilutant and the animal waste matter is collected;
sampling the slurry, wherein a sample of the slurry is collected;
estimating the volume of the slurry, wherein the volume of the slurry is calculated;
measuring the total ammonium nitrogen of the slurry, wherein the total ammonium nitrogen is measured and recorded;
analyzing the pH of the slurry;
determining an amount of acid to be added to the dilutant, wherein the determination considers the pH and total ammonium nitrogen present in the slurry;
adding acid to the at least one source of the dilutant, wherein the acid is added to the dilutant prior to integrating with the animal waste;
deploying acidified dilutant to rinse at least a portion of the barn floor;
collecting a second slurry, wherein the second slurry of animal waste matter and the acidified dilutant are collected;
measuring the total ammonium nitrogen of the second slurry;
ensuring a reduction of the total ammonium nitrogen in the second slurry,
wherein the reduction of total ammonium nitrogen will inhibit struvite formation in the second slurry.

2. The method of inhibiting struvite formation that occurs during the process of removal and management of animal waste matter as recited in claim 1, wherein the acid is sulfuric acid.

3. The method of inhibiting struvite formation that occurs during the process of removal and management of animal waste matter as recited in claim 2, wherein the at least one dilutant source is selected from one of the following: well water, municipal water, collected rain water or recycled water.

4. The method of inhibiting struvite formation that occurs during the process of removal and management of animal waste matter as recited in claim 3, and further including a step of measuring consecutive batches of slurry, wherein each consecutive batch of slurry produced is measured for pH and total ammonium nitrogen.

5. The method of inhibiting struvite formation that occurs during the process of removal and management of animal waste matter as recited in claim 4, and further including a step of discharging a slurry stream, wherein the collected slurry is discharged from a collection area.

6. The method of inhibiting struvite formation that occurs during the process of removal and management of animal waste matter as recited in claim 5, and further including a step of filtering the slurry stream utilizing reverse osmosis, wherein the slurry stream is filtered to create a source of filtered dilutant.

7. The method of inhibiting struvite formation that occurs during the process of removal and management of animal waste matter as recited in claim 6, and further including a step of discharging the slurry to a lagoon storage.

8. The method of inhibiting struvite formation that occurs during the process of removal and management of animal waste matter as recited in claim 7, wherein the consecutive batches of slurry maintain a level of total ammonium nitrogen that is below one hundred parts per million.
